(19) United States
(12) Patent Application Publication
(10) Pub. No.: US 2025/0305673 A1
(43) Pub. Date: Oct. 2, 2025

(54) Fan

(71) Applicant: Vornado Air, LLC, Andover, KS (US)

(72) Inventors: Byron Loibl, Wichita, KS (US); Gregory Pease, Andover, KS (US); Anthony Fischer, Wichita, KS (US); Joshua Weed, Wichita, KS (US); Brian M Cartwright, Wichita, KS (US)

(21) Appl. No.: 19/239,761

(22) Filed: Jun. 16, 2025

Related U.S. Application Data
(63) Continuation-in-part of application No. 29/861,562, filed on Nov. 30, 2022, now Pat. No. D1079922.

(51) Int. Cl. F21V 33/00; F04D 25/08; F04D 29/40

(52) U.S. Cl. CPC F21V 33/0096; F04D 25/08; F04D 29/403

(57) ABSTRACT

A fan includes a vertically oriented body positioned between a base and a top housing. The body is configured to rotate or oscillate about a vertical axis while the base and top housing remain stationary. A connecting member is secured between the base and the top housing and positioned rearward of the body. The connecting member houses a rearward-facing light source configured to emit ambient light. The base of the fan also includes an upward-facing light source positioned encircling the body to provide 360-degree radial illumination. An oscillation mechanism is housed within the base and includes a motor-driven gear assembly that imparts horizontal oscillatory movement to the body. Lighting elements on the base and connecting member are controllable via a user interface or wireless communication module to produce customizable lighting effects including color and brightness.

### RELATED APPLICATIONS

This application is filed as a continuation-in-part of U.S. Design patent application Ser. No. 29/861,562, filed on Nov. 30, 2022, titled “TOWER FAN,” the entire contents of which are incorporated by reference herein.

### FIELD OF THE INVENTION

The invention relates to a fan, and particularly, an electric tower fan having a vertically oriented oscillating body structurally supported between a stationary top and base with integrated lighting systems for ambient illumination.

### BACKGROUND OF THE INVENTION

Electric fans are widely used in residential, commercial, and industrial settings for air circulation, cooling, and ventilation. Oscillating fans, such as tower fans in particular, are commonly employed to distribute airflow across a broader area by periodically rotating their air outlet side-to-side. Traditional oscillating fans typically consist of a fan body mounted atop a base, with the body pivoting relative to the base using internal motors and gear systems. While these designs offer effective air dispersion, they often suffer from issues of mechanical instability, misalignment over time, and complex internal wiring due to the movement of key components during oscillation.

Furthermore, existing fan designs frequently prioritize function over form, providing limited aesthetic appeal or user-centric features beyond basic airflow control. In recent years, consumers have increasingly sought multifunctional devices that combine utility with modern design and environmental adaptability. Lighting features integrated into household appliances, especially mood or accent lighting, have become desirable, but in many fan products, such features are added as afterthoughts or require external attachments that complicate manufacturing, reduce reliability, or interfere with oscillatory motion.

There is therefore a need in the art for an oscillating fan that offers improved structural stability, reduced vibrational noise, and simplified mechanical design while simultaneously enabling integration of lighting features. The present invention addresses these and other shortcomings.

### SUMMARY OF THE INVENTION

The present invention is directed to a fan that includes a vertically oriented body positioned between a base and a top housing, where the body houses a blower driven by a motor for generating airflow. The body is configured to move, such as through oscillation, relative to the base and the top housing, allowing for directional air circulation across a desired range. To enhance structural rigidity and alignment, the fan includes a connecting member that extends between and is fixedly secured to both the base and the top housing. This connecting member remains stationary during movement of the body and serves to stabilize the overall assembly, reduce mechanical vibration, and prevent misalignment over time.

In other examples, the fan further includes a first light source disposed on or within the connecting member. This light source is configured to illuminate light rearwardly, providing ambient illumination and enhancing visual appeal, particularly when positioned near a wall surface. Additionally, the fan may include a second light source integrated into the base, which is configured to illuminate light upwardly along the vertical axis of the fan. This base-mounted light source may encircle the body and produce uniform radial lighting directed toward the top housing. Both lighting systems may be configured for independent or synchronized control, enabling various visual effects such as color blending, dimming, or mood lighting, thereby transforming the fan into a multifunctional comfort and aesthetic appliance.

Other devices, apparatus, systems, methods, features and advantages of the invention are or will become apparent to one with skill in the art upon examination of the following figures and detailed description. It is intended that all such additional systems, methods, features and advantages be included within this description, and be within the scope of the invention, and be protected by the accompanying claims.

### BRIEF DESCRIPTION OF THE FIGURES

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a front perspective view of one example of an implementation of a fan of the present invention.

FIG. 2 is a left side view of the fan of FIG. 1.

FIG. 3 is a rear top perspective view of the fan of FIG. 1.

FIG. 4 is a top view of the fan of FIG. 1.

FIG. 5 is an exploded view of the fan of FIG. 1.

FIG. 6 is an exploded view of the top of the fan of FIG. 1.

FIG. 7 is an exploded view of the body of the fan of FIG. 1.

FIG. 8 is an exploded view of the base of the fan of FIG. 1.

### DESCRIPTION OF THE INVENTION

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

Further, in this application, the terms “substantially,” “approximately,” or “about,” when modifying a specified numerical value, may be taken to encompass a range of values that include +/−10% of such numerical value. Further, terms such as “communicate,” and “in . . . communication with,” or “interfaces” or “interfaces with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate or interface with a second component is not intended to exclude the possibility that additional components may be present between, and/or operatively associated or engaged with, the first and second components.

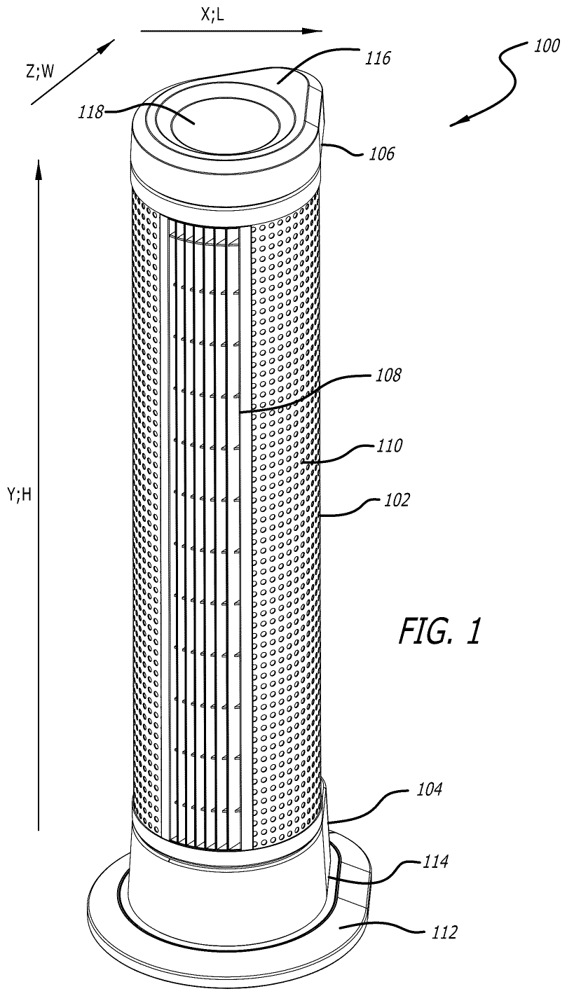

For purposes of reference and description, the fan 100 of the present invention is considered to have a horizontal x-axis (x), vertical y-axis (y) and a width z-axis (z), as shown in FIG. 1 along which the components of the fan 100 are positioned relative to each other. Terms such as “axial” and “axially” are assumed to refer to the respective axis or any direction or axis parallel to the device axis, unless indicated otherwise or the context dictates otherwise. For convenience, movement relative to a device axis may alternatively encompass movement relative to an axis that is parallel to the device axis that is specifically illustrated in FIG. 1, unless the context dictates otherwise. Thus, linear translation “along the device axis z” is not limited to translation directly on (coincident with) the device axis, but also encompasses translation parallel to the device axis z, depending on the context. Similarly, rotation “about the device axis y” also encompasses rotation about an axis that is parallel to the device axis y, depending on the context.

Further, the fan of the present invention is also considered to have a height (h), length (l) and width (w), as also shown most notably shown by arrows in FIG. 1. It should be understood that the height (h), length (l) and width (w) directions also applies to all internal components of fan 100.

As illustrated and discussed in the following, an example of a fan 100 that oscillates is provided. In the example, the fan 100 is a portable, free-standing fan. “Portable” being defined as having the ability to be carried or moved with ease. “Free standing” being defined as having the ability to remain stable and upright without external restraints. It should further be understood that the term “fan” may be interchangeably used with the terms “air blower, “air circulator” or any other term that refers to an apparatus that creates a current of air for cooling and/or heating.

As shown in FIGS. 1-8, one example of a fan 100 of the present invention is illustrated. FIG. 1 is a front perspective view of one example of an implementation of the fan 100 of the present invention. In particular, fan 100 comprises of a top 106, body 102, and base 104. Body 102 is positioned between the top 106 and base 104. In particular, body 102 is vertically disposed between top 106 and base 104 and oscillates relative to top 106 and base 104. In other words, body 102 moves relative to top 106 and base 104, while top 106 and base 104 remain stationary. This configuration defines in general, a three-part architecture in which the central oscillating body 102 is suspended between two rigid, non-oscillating components, namely, base 104 and top 106. Each of the three primary subassemblies (top 106, body 102, and base 104) serves multiple roles, with body 102 handling air movement and oscillation, base 104 handling power input, oscillation drive, and stabilization, and top 106 handling control interfaces and upper mechanical bracketing. The result is a fan apparatus 100 designed to offer superior air circulation, user interface, and aesthetic appeal in both residential and commercial environments.

The vertically oriented body 102 is designed not merely as a housing, but as the primary actuator assembly responsible for generating and directing airflow. Its placement between base 104 and top 106 enables a wide oscillation range in the horizontal or x-axis plane while maintaining vertical alignment and center of gravity in a position optimized for both performance and stability. Additionally, the confined vertical span between the fixed base 104 and fixed top 106 provides a physical limit that governs the extent of lateral tilt or sway during oscillation, thereby functioning as an integrated mechanical safeguard against over-rotation or misalignment.

Body 102 is an elongated, vertically oriented enclosure that houses, in general, an air blower assembly, such as an axial or centrifugal blower 702 powered by motor 502. Blower 702 is positioned within an interior space of body 102 and receives ambient air through air intake openings positioned on the left and right-side housing 704, 706 of body 102 for generating airflow. These intake openings may be configured as slotted vents, louvers, mesh screens, or decorative perforations, and may be symmetrically or asymmetrically distributed to optimize aerodynamic flow distribution around blower 702. In some embodiments, acoustic baffling or internal noise suppression materials may line the intake regions to reduce fan noise and vibration.

Body 102 also includes an air outlet defined by outlet grill 108. In operation, air enters through the air intake openings and exits through the outlet grill 108. Outlet grill 108 may be a front-facing vertical grill that extends along a substantial height of the body housing 102. The elongation of outlet grill 108 along the vertical or y-axis enables wide-angle air dispersion and uniform airflow projection across a large vertical surface area, improving circulation efficiency in both seated and standing user positions. Grill 108 may incorporate directional vanes or aerodynamic louver structures to focus or shape the exiting airflow.

Body 102 may further include a sleeve 110 that at least partially surrounds blower 702. Sleeve 110 may be comprised of a mesh screen having a plurality of openings. The plurality of openings also provides another opening for the ambient air to flow through before it flows through the air intake openings positioned on the left and right-side housing 704, 706 of body 102. Sleeve 110 may also act as an airflow conditioning element, regulating and evening out the velocity profile of incoming air prior to impingement on blower 702. In some examples, sleeve 110 may be formed from acoustically absorbent or vibration-dampening materials to further minimize operational noise. The sleeve's geometry may be cylindrical, elliptical, or otherwise contoured to conform around blower 702 while maintaining a flow-friendly clearance. Outlet 108 serves as the final exhaust path for the airflow generated internally by fan 100. Collectively, the internal air handling system within body 102 enables fan 100 to deliver powerful, smooth, and consistent airflow while maintaining a compact, vertically integrated profile.

Fan 100 also includes controls or controller 116 positioned on the top cap 118 of fan 100 for controlling the various operations of fan 100. Controller 116 allows the user to toggle between blower speeds, oscillation modes, lighting controls, and power on/off states. Controller 116 may be configured as a capacitive touch panel, mechanical button interface, rotary dial, touchscreen, or any combination thereof, and may include one or more feedback indicators such as multicolor LEDs, segment displays, or haptic feedback mechanisms to convey operational status, error codes, or active settings.

In some examples, controller 116 may include capacitive touch inputs, LED indicators, or wireless communication modules for remote operation by a remote control or a wireless communication module compatible with electronic devices such as smartphones and mobile applications. Controller 116 may include a pairing button, secure authentication protocols, or over-the-air firmware update capabilities to maintain connectivity, performance, and security standards.

Top cap 118 may further include a recessed portion for holding a remote control. The recessed region may be dimensioned to magnetically or frictionally retain a handheld remote device, thereby reducing clutter and improving user accessibility. In certain embodiments, the recess may include a wireless charging pad for inductively recharging a rechargeable remote control or other compatible smart devices, such as smartphones or wearable electronics.

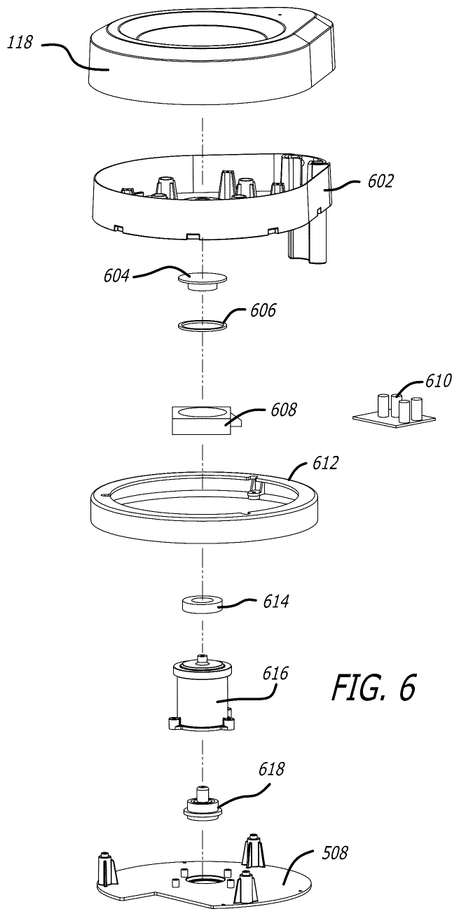

Internally, controller 116 may be electrically connected to a printed circuit board assembly (PCBA) 614 housed within control tray 602 (as shown in FIG. 6), which governs the operational logic of motors 502, 816, light sources 114, 302, and sensor systems. The PCBA's discussed herein may include microcontrollers, drivers, memory storage, voltage regulators, and power management circuitry, enabling it to interpret user inputs, generate appropriate control signals, manage safety conditions (e.g., thermal limits, current overload), and provide bidirectional communication to external devices.

Base 104 includes a base plate 112 and one or more feet 210 positioned below base plate 112 for supporting fan 100 to remain stable and upright without external restraints on a surface. Base 104 is defined by the portion of fan 100 that supports the body 102 and top 106 above a support surface. Base 104 functions as a foundational structural housing and mechanical anchor that accommodates not only the vertical weight of fan 100 but also the lateral forces generated during oscillatory motion of body 102. The feet 210 may include elastomeric pads, anti-slip textures, or vibration-damping inserts to ensure traction and noise minimization on a wide range of floor surfaces, such as hardwood, tile, or carpet.

As will be discussed in greater detail below, base 104 further houses an oscillation mechanism configured to impart horizontal oscillatory motion to the body 102. Base 104 also serves as the lower attachment point for connecting member 202, which is fixedly secured at its second end 204 to a top-facing structural region of base 104.

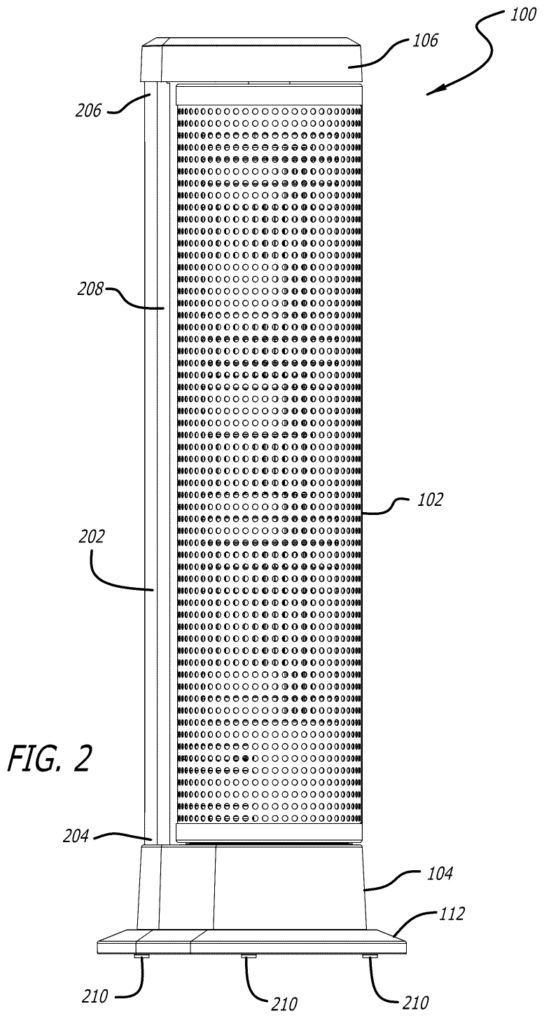

FIG. 2 is a left side view of the fan 100. As stated above, the top 106 is stationary and non-oscillating. Top 106 is physically coupled to base 104 via a connecting member 202, which runs longitudinally along a rear or lateral portion of fan 100. Connecting member 202 serves as a static, vertically oriented member that bridges the top 106 and base 104. Unlike body 102, which is configured to oscillate, connecting member 202 remains completely stationary during operation, thereby acting as a structural frame element that constrains and supports oscillating body 102.

Connecting member 202 may be designed to be a vertical bar having a first end 206 for fixedly attaching to an underside of top 100 or underside of top cap 118 of top 106 and an opposing second end 204 for fixedly attaching to the top side of main housing 814 of base 104. These connections may be achieved through mechanical fasteners, molded interface bosses, vibration-dampening mounts, or snap-fit retention systems. The mechanical joint between the connecting member 202 and the stationary top and base housings is engineered to withstand both static loads (e.g., the gravitational mass of the housing) and dynamic loads (e.g., torque induced during oscillation cycles).

Connecting member 202 may further by positioned at a distance from body 102, thereby creating a gap 208 to allow body 102 room to oscillate relative to top 106, base 104 and connecting member 202. Gap 208 is dimensioned to provide mechanical clearance for the full angular sweep of body 102 during oscillation.

Body 102 is mechanically secured to both top 106 and base 104 via a pivot mechanism that utilizes ball bearings 614, 804 that permit relative horizontal or oscillating rotation about the y-axis while restricting vertical or lateral displacement. As stated above, the oscillating rotation of body 102 is imparted by an oscillating mechanism positioned within or on base 104. These pivoting ball bearing systems are positioned concentrically around the central vertical axis of blower 702 or body 102 and provide low-friction rotational freedom, allowing body 102 to pivot smoothly back and forth without mechanical binding, chatter, or alignment drift.

By attaching to both the top 106 and base 104, connecting member 202 provides structural reinforcement by transmitting counteractive mechanical force to the top 106, thereby creating a stabilizing moment arm that offsets oscillatory torque. This results in a mechanically balanced system in which the inertial mass of the oscillating body 102 is effectively dampened and redirected through the fixed frame, improving the fan's stability and reducing long-term fatigue on moving components. Connecting member 202 further provides counterbalancing by redistributing mass away from the axis of rotation of body 102, aiding smooth inertial movement. This off-axis distribution improves angular momentum control, contributing to a more natural and fluid oscillation rhythm with reduced motor strain and enhanced responsiveness to control inputs.

It should be understood that while connecting member 202 is shown as a vertical bar design, connecting member 202 may be constructed in a variety of different aesthetic designs without departing from its utilitarian functionality. For example, as an alternative to the vertical bar design as shown in the figures, the design of connecting member 202 may include but is not limited to a zig-zag bar, curved bar or wavy bar. Such aesthetic designs are viable alternatives to achieve the same utilitarian benefits as the vertical bar design as shown in the figures. Such geometric variations may be implemented for visual differentiation while retaining the same structural function of anchoring top 106 to base 104 and remaining outside the oscillation envelope of body 102.

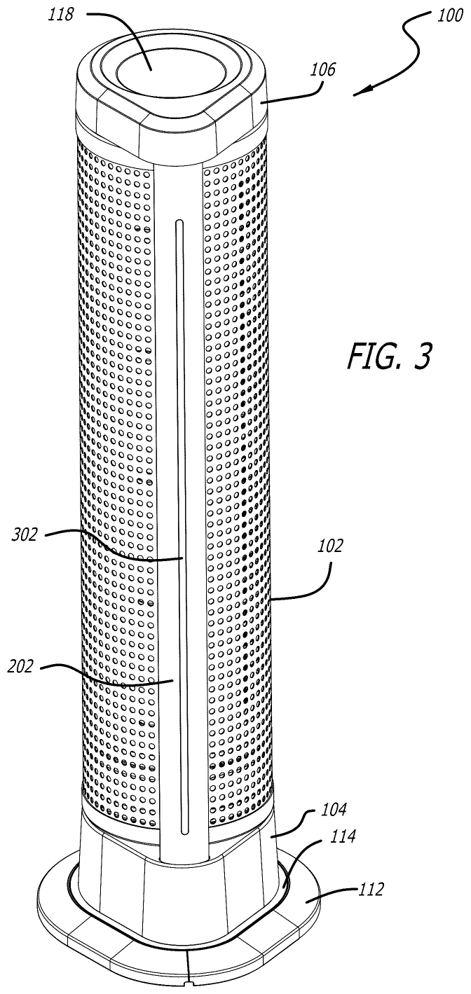

FIG. 3 is a rear top perspective view of fan 100. As shown, base 104 includes a light source 114. Light source 114 may be formed of a ring and comprise of one or more light source elements, such as light emitting diodes or fiber optics. Light 114 is oriented and/or configured to emit light upward from the base to create uplighting to fan 100. In the present example, light 114 may be positioned substantially near the circumferential perimeter edge of body 102 to emit light onto body 102. The placement of light source 114 in this manner enhances visual definition of the vertically oriented body 102 by creating a subtle wash of illumination across its surface, producing a glowing pedestal effect that elevates the appearance of the fan in dimly lit or ambient environments. The ring-like configuration of light source 114 allows for uniform radial distribution or emission of light around body 102, minimizing shadows and producing smooth, aesthetic visual gradients.

As also shown in FIG. 3, a light source 302 may be positioned on connecting member 202. Similar to light source 114, light source 302 may comprise of one or more light source elements, such as light emitting diodes or fiber optics. In the present example, light source 302 may be constructed as a strip that runs along the vertical height of connecting member 202. Light source 302 is configured to emit light rearward, thereby producing a glow on the wall or surface behind fan 100. This rear-oriented lighting effect creates an architectural backlighting element that casts a halo or silhouette of the fan housing onto the wall surface, enhancing the fan's presence in the room and contributing to mood lighting schemes commonly used in home and commercial settings. The rear glow effect also enhances perceived depth and dimensionality of the product when viewed from the front or side, particularly in dark environments.

As stated above, light sources 114, 302 may be connected to a printed circuit board (either separate circuit boards or the same circuit board) which receives input from controller 116, a remote control device, or a wireless communication module compatible with electronic devices such as smartphones and mobile applications. In some embodiments, each light source 114, 302 may be addressable independently or in zones, allowing for programmable lighting sequences and effects. Such control logic may reside in a central PCBA or distributed lighting driver circuits, and may support wired or wireless firmware updates for expanding functionality post-sale.

In one example, controls for both light sources or regions 114, 302 (located on base and bar) can be configured to provide the following functionalities, either independently, or simultaneously with one another: Full-spectrum Red, Green, Blue (RGB) color blending, brightness adjustment (via for example, Pulse Width Modulation), patterned effects (e.g., fading, pulsing, cycling etc.), preset modes (e.g., reading light, night light, mood glow etc.), and synchronization with environmental sensors, fan blower speed, or audio input. This multimodal lighting system transforms fan 100 into a customizable ambient lighting appliance that can respond dynamically to environmental cues or user preferences. For instance, the lighting may automatically dim when the room is darkened, shift hues according to fan speed (e.g., cooler tones at higher speeds), or pulse rhythmically with music input to create a synesthetic user experience.

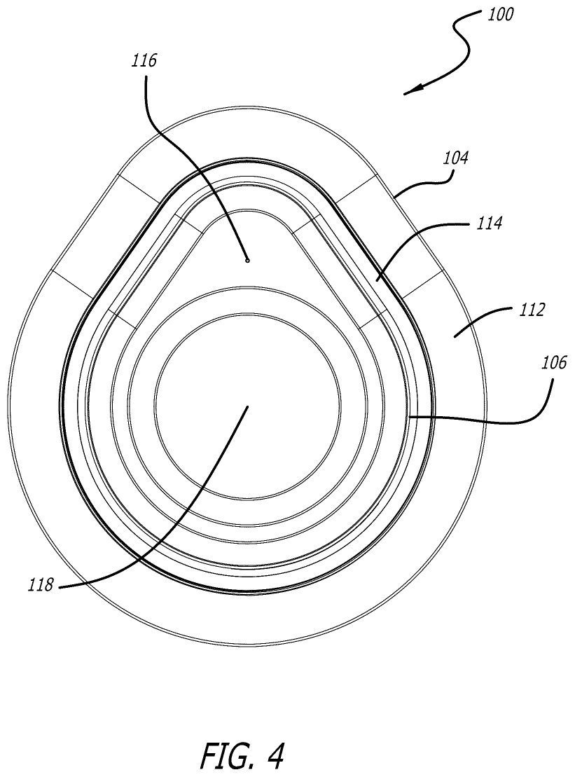

FIG. 4 is a top view of fan 100. FIG. 4 shows light source 114 formed as a strip positioned on base plate 112 encircling main base housing 814. In the illustrated embodiment, light source 114 is arranged in a continuous or segmented annular configuration positioned concentrically or near-concentrically on base plate 112 around the outer base perimeter of base main housing 814. This placement ensures that light emission occurs in a 360-degree radial pattern when viewed from above, maximizing the spatial uniformity of upward lighting around body 102.

Additionally, when viewed from the top of fan 100, no portion of light source 114 is obstructed by any component parts of fan 100. Specifically, base plate 112 and main base housing 814 are dimensioned and shaped to avoid overhang or shadow-casting structures above the light-emitting elements of light source 114. The structural geometry thus ensures full optical exposure of light source 114, enabling it to distribute light evenly in all directions around the body 102 without visual occlusion or hotspot artifacts.

Such configuration of light source 114 emits light uniformly around the body 102 of fan 100. This light dispersion produces a consistent halo effect at the base of fan 100, enhancing visual aesthetics by providing balanced uplighting along the full circumference of the oscillating body 102. The optical smoothness of the lighting (in both light source 114 and 302) may be further enhanced by the use of a translucent diffuser, lens array, or frosted cover integrated into or over the light source 114, 302, which serves to blend and soften the appearance of individual light source elements.

In some examples, the light source 114, 302 may be divided into independently addressable sectors (e.g., quadrants or arcs), allowing for region-specific lighting effects such as directional highlighting, rotating color sequences, or interactive animations. Such dynamic lighting modes may be user-configurable via controller 116 or a mobile application, with saved presets corresponding to specific moods or user routines (e.g., wake-up light, evening relax, party mode etc.).

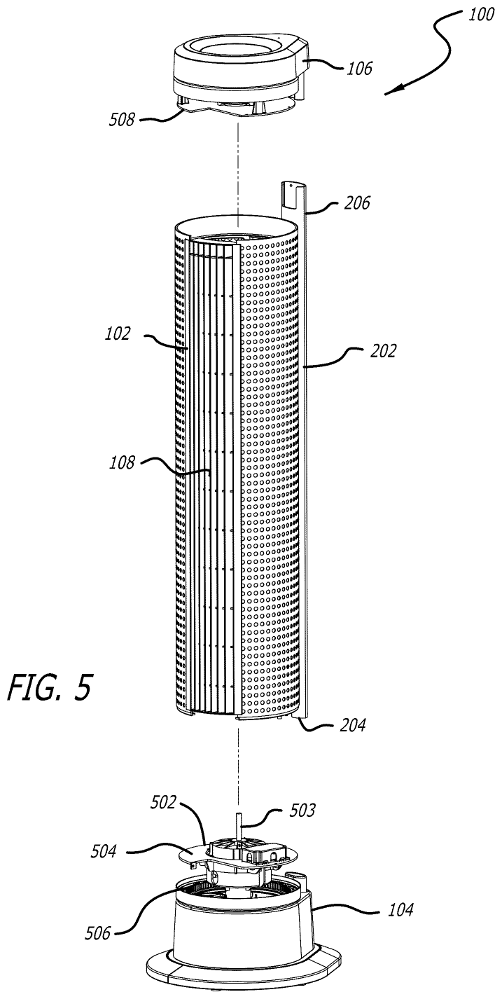

FIG. 5 is an exploded view of fan 100. In particular, fan 100 comprises of top 106, body 102, and base 104. These three primary components are shown disassembled to illustrate the internal architecture, mechanical interface points, and functional subassemblies that collectively define the structural and operational framework of fan 100.

Top 106 may house several components, including but not limited to bearing bulkhead 508 for providing a secure mounting housing for the fan bearing components to allow body 102 to rotate or oscillate smoothly with minimal friction relative to top 106. The bearing bulkhead 508 is configured as a rigid, load-distributing platform that interfaces directly with the upper pivot mechanism of body 102, ensuring precise axial alignment during oscillation and preventing undesired lateral play.

Body 102 comprises of a blower 702 for generating airflow and outlet grill 108 for emitting airflow generated by blower 702. Blower 702 is mechanically driven by motor 502 (mounted within base 104), via a motor shaft 503, and is preferably positioned within the geometric center of body 102 to promote symmetric airflow output and oscillation balance. The outlet grill 108 is mounted at the front of body 102 and aligned with the blower outlet, ensuring efficient conversion of axial or centrifugal airflow into a directed, high-velocity air stream.

FIG. 5 also shows connecting member 202 and its two ends 204, 206 that may be fixedly attached to base 104 and top 106, respectively. Connecting member 202, in this disassembled view, appears offset from the main vertical centerline of body 102, thereby illustrating its deliberate spatial separation from the oscillating body 102. This allows body 102 to swing or rotate freely in a controlled angular range while connecting member 202 remains rigid and stationary, creating a fixed reference frame spanning the top 106 and base 104. Each of the ends 204, 206 may be fitted with mounting brackets, molded detents, or structural fastener bosses for robust mechanical coupling to the base 104 and top 106 housings.

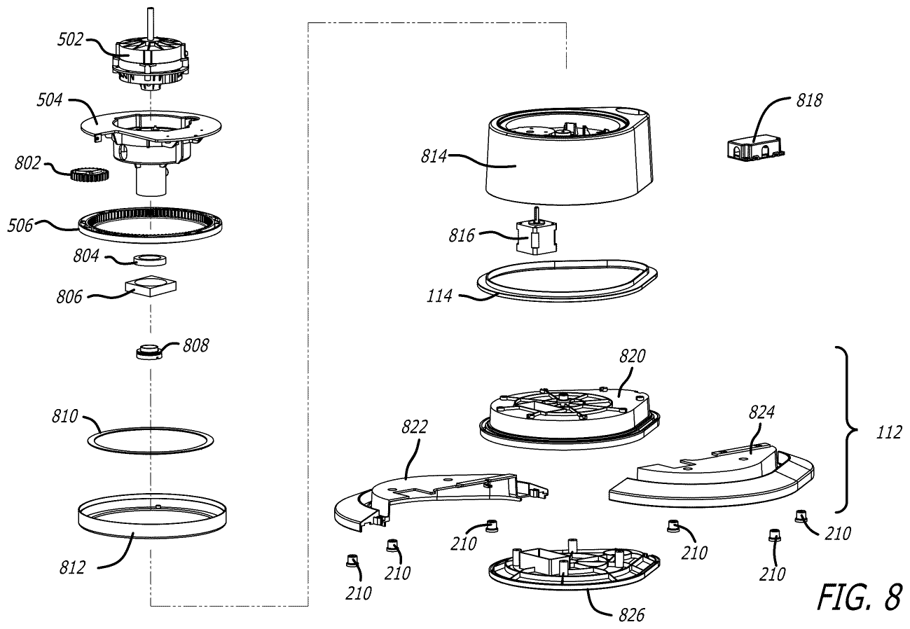

Base 104 may also house several components, including but not limited to blower motor 502, motor mount 504 and oscillation gear 506. Blower motor 502 mechanically moves or rotates blower 702 via a motor shaft 503 for generating airflow. The motor mount 504 is positioned within base 104 and functions to rigidly hold blower motor 502 in place while absorbing vibrational loads. Oscillation gear 506 is positioned beneath or around motor 502 and is driven by an additional motor (e.g., motor 816, described in FIG. 8) for producing oscillatory motion. The integration of both the blower drive system and oscillation drive system into the base 104 ensures that all dynamic mechanical components remain anchored to the stationary portion of the fan, with only the blower and body 102 undergoing oscillation movement. This configuration simplifies wiring, improves thermal management, and enhances structural balance during operation.

FIG. 6 is an exploded view of the top 106 of fan 100. As shown, top 106 comprises of a top cap 118, control tray 602 and bearing bulkhead 508. Top cap 118, control tray 602 and bearing bulkhead 508 remain stationary as body 102 oscillates. Top 106 serves as a multifunctional, non-rotating upper subassembly that houses critical control electronics, provides axial alignment and bearing support for the oscillating body 102, and interfaces structurally with connecting member 202 at its upper end 206.

Top 106 further houses components that facilitate or aid in rotation or oscillation of body 102. In particular, body 102 is mechanically secured to top 106 via a pivot mechanism that utilizes ball bearing components. These bearing components allows body 102 to rotate smoothly with minimal friction relative to the fixed top 106. In particular, a bearing plate 604, bearing retainer 606, bearing cap 608, ball bearing 614, bearing mount 616, and blower bearing 618 are provided to allow body 102 to rotate or oscillate smoothly with minimal friction relative to top cap 118, control tray 602 and bearing bulkhead 508 of top 106. Specifically, bearing plate 604 is rigidly affixed to the upper portion of body 102 and serves as the rotational base interface that translates the angular motion of body 102 into rotational input for the bearing system. Ball bearing 614 is seated within bearing retainer 606, which is concentrically aligned with and supported by bearing mount 616, and is held in axial compression by bearing cap 608. This stacked assembly forms a rotary bearing race that reduces friction and supports radial and axial loads imposed by the oscillating mass of body 102. Blower bearing 618, which may be concentrically aligned with the blower motor shaft or its housing, further ensures rotational stability by constraining torsional deflection and maintaining shaft alignment during oscillation. Together, these components cooperate to maintain precise coaxial alignment between the rotating body 102 and the fixed top 106 while distributing mechanical loads evenly across the bearing structure, thereby enabling smooth, durable, and low-noise oscillatory motion.

Control tray 602 may further house a printed circuit board assembly (PCBA) 610, which may be in communication with controller 116 and motors 502, 816. Control tray 602 functions as a rigid electronics platform, securely supporting PCBA 610 while isolating it from mechanical vibration and environmental contaminants. PCBA 610 is electrically connected to user interface controller 116 and may serve as the central processing and distribution hub for all electrical signals throughout the fan. This includes interpreting user inputs, modulating motor speeds, toggling lighting modes, and managing wireless communication protocols. PCBA controls may include microcontrollers and drivers for managing power distribution, motor control logic, sensor input processing, and wireless communication for the remote interface. The integration of PCBA with controller 116 on the top of the fan 100 also provides ergonomic access for on-device adjustments.

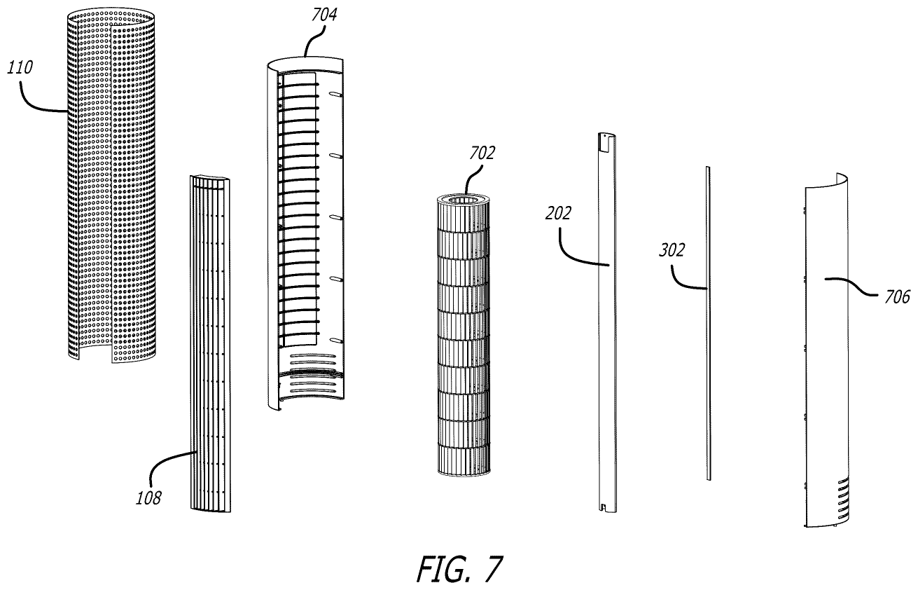

FIG. 7 is an exploded view of the body 102 of fan 100. As stated above, body 102 comprises of blower 702, outlet grill 108, side housings 704, 706, either of which may include inlet openings or an inlet grill for receiving ambient air, and sleeve 110. This central subassembly is configured as a vertically elongated shell designed to house and align the internal airflow generation components, while maintaining structural integrity and balanced mass distribution during oscillation.

Blower 702, outlet grill 108, side housings 704, 706 and sleeve 110 rotate or oscillate relative to top 106 and base 104. Blower 702 is centrally mounted within body 102 and is driven by motor 502 via a drive shaft 503 extending vertically from the base. Ambient air is drawn into the internal chamber of body 102 through opposing side inlets located within housings 704 and 706 and then accelerated through the blower 702 impeller. The resulting high-velocity airflow is channeled forward and expelled through outlet grill 108, which may include flow-directing vanes to shape the air stream and improve directional projection.

Also shown in FIG. 7 is connecting member 202 and light source 302. Connecting member 202 may run the entire vertical height of body 102, namely blower 202. Light source 302, shown affixed to connecting member 202, may be configured as a vertically aligned LED strip or fiber optic channel that spans a substantial portion of the connecting member's height. Because the connecting member 202 does not oscillate with body 102, light source 302 remains static and can project a consistent rearward glow.

FIG. 8 is an exploded view of the base 104 of fan 100. As shown, base 104 comprises of a main housing 814, base plate 112 having a left 822, middle 820, and right 824 component, a light source 114, a base cap 826 and feet 210. The exploded view illustrates how these components interlock or fasten together to form a structurally rigid platform that anchors fan 100. Main housing 814 serves as the central mechanical cavity for housing internal motors, gears, and electronics, while base plate 112 forms the structural bottom layer that interfaces with the floor or surface.

Light source 114 may be mounted to or integrated with base plate 112 and positioned to encircle main housing 814. Base cap 826 underlays the assembly. Feet 210, mounted beneath base plate 112, may be constructed of rubber, silicone, or other elastomeric material and are designed to dampen mechanical vibration and prevent slippage on hard or soft surfaces.

Main housing 814, base plate 112, light source 114, base cap 826 and feet 210 remain stationary as body 102 oscillates. Similar to top 106, base 104 also houses components that facilitate or aid in rotation or oscillation of body 102. In particular, body 102 is mechanically secured to base 104 via a pivot mechanism that utilizes ball bearing components to allow body 102 to rotate or oscillate smoothly with minimal friction. The ball bearing components may include ball bearing 804, bearing cap 806, bearing plate 808 and thrust bearing 810. These components work in concert to form the lower half of the fan's oscillation pivot system. Ball bearing 804 is seated within bearing plate 808 and axially constrained by bearing cap 806 and thrust bearing 810, enabling low-friction, load-bearing rotation of body 102 about the vertical axis. The dual-bearing architecture disclosed in both the top 106 and bottom 104-top and bottom 104 ensures smooth, well-aligned oscillation even under continuous use or variable speed modes.

Base 104 further includes an oscillation mechanism for oscillating body 102. The oscillating mechanism may comprise of at least a motor 816 (such as a stepper motor), drive gear 802, and oscillation gear 506. Motor 816 is in communication with drive gear 802 such that motor 816 mechanically moves or rotates drive gear 802 via a motor shaft. The teeth of drive gear 802 mesh with the teeth of oscillation gear 506, causing drive gear 802 to traverse along the curved path of oscillation gear 506. Oscillation gear 506 is mounted in a fixed position within base 104 and may be shaped as a segment of a circular arc, such as a semi-circular or partial circular gear.

In operation, motor 816 rotates drive gear 802 in a first direction such that it traverses along the curvature of oscillation gear 506, thereby causing body 102 to rotate horizontally about the y-axis. Upon reaching a predetermined angular limit, the motor reverses direction, causing drive gear 802 to move in the opposite direction along the same gear path—thus enabling body 102 to perform continuous oscillation. This bi-directional movement creates a rhythmic side-to-side sweeping motion that evenly distributes airflow throughout the room. The rotational displacement of body 102 is tightly governed by the arc length and center radius of oscillation gear 506, allowing precise control over oscillation angle. In some embodiments, oscillation range may be mechanically limited by gear stops or electronically limited via input from a control signal.

Motor 816 may be driven by control signals from controller 116 and/or a remote control, enabling the user to select predefined oscillation settings (e.g., 45°, 90°, 180° sweep) or initiate continuous or adaptive oscillation modes. In programmable modes, oscillation speed, acceleration curves, and sweep frequency may be modulated by microcontroller algorithms to match user-selected airflow patterns or to dynamically respond to ambient sensor data. It should also be understood that while the curvature of oscillation gear 506 is shown to extend 360 degrees, the length of oscillation gear 506 can extend to any angular value between 0 and 360 degrees without departing from the scope of the invention. Therefore, the oscillating mechanism of the present invention may allow body 102 to oscillate between ranges of 0° and 90°, 0° and 180°, or any range up to a full 360° sweep relative to base 104 and top 106.

One or more Hall sensors (not shown) may also be incorporated in fan 100. These Hall-effect sensors may be in communication or signal connection with motor 816 to control the direction of rotation of drive gear 802 such that drive gear 802 rotates clockwise and counterclockwise for moving back and forth along oscillation gear 506 to create the oscillating motion. In other words, one or more sensors, optionally operating in conjunction with one or more magnets (not shown), may provide a signal to motor 816 when drive gear 802 has reached an end of oscillation gear 506 so that the motor reverses direction. This sensor-driven reversal allows for precise, repeatable, and silent switching of oscillation direction without reliance on mechanical limit switches, which are prone to wear or misalignment over time.

Base 104 may further house a printed circuit board assembly (PCBA) 818, which may be in communication with controller 116 and motors 502, 816. PCBA 818 may function as the centralized control and power distribution hub for all components located within base 104, including oscillation motor 816, airflow motor 502, lighting assemblies (e.g., 114), and sensor arrays. The PCBA 818 may include microcontrollers, motor drivers, voltage regulators, wireless communication modules, and thermal protection circuits.

The controller for the fan disclosed herein may be one or more modules, control units, components, or the like configured for controlling, monitoring, analyzing and/or timing the operations of various devices or components of the fan, as well as controlling or executing one or more steps of any of the methods disclosed herein In addition to the components of fan described above, the fan may include alternative electrical power (voltage) sources, timing controllers, fuses, clocks, processors, integrated circuits, logic circuits, memories, databases, etc. One or more modules of the controller may be, or be embodied in, one or more devices located outside or separate from the fan, for example, a computer workstation, desktop computer, laptop computer, portable computer, tablet computer, handheld computer, mobile computing device, personal digital assistant (PDA), smartphone, remote control, etc. One or more modules of the controller may communicate with one or more other modules via one or more busses or other types of communication lines or wireless links, as appreciated by persons skilled in the art.

In the illustrated implementation, the controller may include one or more electronics-based processors, which may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The controller also includes one or more memories (volatile and/or non-volatile types, e.g. RAM and/or ROM) for storing data and/or software. Stored data may be organized, for example, in one or more databases or look-up tables. The controller may also include one or more device drivers for controlling one or more types of user interface devices and providing an interface between the user interface devices and components of the controller communicating with the user interface devices. Such user interface devices may include user input devices (e.g., buttons, switches, keyboard, keypad, touch screen, mouse, joystick, trackball, and the like) and user output devices (e.g., display screen, printer, visual indicators or alerts, audible indicators or alerts, and the like). In various implementations, the controller may be considered as including one or more of the user input devices and/or user output devices, or at least as communicating with them.

In some implementations, the controller may also include one or more types of computer programs or software contained in memory and/or on one or more types of non-transitory (or tangible) computer-readable media. One or more devices of the controller may be configured to receive and read (and optionally write to) the computer-readable media. The computer programs or software may contain non-transitory instructions (e.g., logic instructions) for controlling or performing various operations of the fan. The computer programs or software may include system software and application software. System software may include an operating system for controlling and managing various functions of the controller, including interaction between hardware and application software. In particular, the operating system may provide a graphical user interface (GUI) displayable via a user output device, and with which a user may interact with the use of a user input device. Application software may include software configured to control or execute various operations of the fan, and/or some or all of the steps of any of the methods disclosed herein.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

Further, it will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A fan comprising:
a base configured to rest on a support surface;
a top housing disposed above the base;
a body positioned vertically between the base and the top housing, where the body comprises a blower in operation with a motor for generating airflow, where the body is configured to move relative to the base and the top housing;
a connecting member having a first end secured to the base and a second end secured to the top housing, where the connecting member remains stationary during movement of the body.

2. The fan of claim 1 where the connecting member extends along the vertical height of the body.

3. The fan of claim 1 where the connecting member is positioned rearward of the body.

4. The fan of claim 1 where the body is configured to oscillate relative to the base and the top housing.

5. The fan of claim 4 where an oscillation mechanism comprising of a drive gear, oscillation gear and motor is disposed in the base and configured to cause the body to oscillate.

6. The fan of claim 1 where a light source is positioned on the connecting member and is configured to illuminate light rearwardly from the fan.

7. The fan of claim 1 where a light source is positioned on the base and is configured to illuminate light upwardly around the body of the fan.

8. A fan comprising:
a base;
a top housing;
a body positioned between the base and the top housing, where the body comprises a blower in operation with a motor for generating airflow, where the body is configured to move relative to the base and the top housing;
a connecting member having a first end secured to the base and a second end secured to the top housing, where the connecting member remains stationary during movement of the body;
a first light source disposed on or within the connecting member and configured to illuminate light rearwardly from the fan.

9. The fan of claim 8, where the first light source extends along a height of the connecting member.

10. The fan of claim 9, where the first light source comprises of a vertically oriented light strip.

11. The fan of claim 8 where the first light source is configured to illuminate light toward a wall surface behind the fan to produce an backlighting effect.

12. The fan of claim 8 where the first light source is controllable via a user interface on the top housing or a wireless remote.

13. The fan of claim 8 where the first light source is operatively connected to a printed circuit board assembly, where the printed circuit board assembly is configured to control lighting effects, color or brightness of the first light source.

14. The fan of claim 8, where a second light source is disposed on or within the base and configured to illuminate light upwardly towards the top housing.

15. A fan comprising:
a base;
a top housing;
a body positioned between the base and the top housing, where the body comprises a blower in operation with a motor for generating airflow;
a light source disposed on or within the base and configured to illuminate light upwardly towards the top housing.

16. The fan of claim 15 where the light source comprises an annular light strip encircling the body.

17. The fan of claim 16 where the light source is configured to illuminate light in a 360-degree pattern around the body.

18. The fan of claim 15 where the light source is operatively connected to a printed circuit board assembly, where the printed circuit board assembly is configured to control lighting effects, color or brightness of the light source.

19. The fan of claim 15 where the light source is controllable via a user interface on the top housing or a wireless remote.

20. The fan of claim 18 where the printed circuit board assembly is in wireless communication with a mobile electronic device, where the electronic device includes a user interface for controlling the lighting effects, color or brightness of the light source.
